(19) United States
(12) Patent Application Publication
(10) Pub. No.: US 2014/0122162 A1
(43) Pub. Date: May 1, 2014

(54) Efficiency System

(71) Applicant: CATERPILLAR GLOBAL MINING LLC, Oak Creek, WI (US)

(72) Inventor: Mark R. Baker, Tucson, AZ (US)

(73) Assignee: CATERPILLAR GLOBAL MINING LLC, Oak Creek, WI (US)

(21) Appl. No.: 13/665,208

(22) Filed: Oct. 31, 2012

(51) Int. Cl. G06Q 10/06; G06Q 50/02

(52) U.S. Cl. 705/7.27

(57) ABSTRACT

A system, and related method and computer program product are disclosed. The system may comprise a loading machine, a first fleet, a second fleet, and a controller operably connected to the loading machine(s) and the first fleet and the second fleet. The controller may be configured to determine a FF System Efficiency for a first scenario based on a FF Mining Efficiency and a FF Percent Shift Time Difference. The controller may be further configured to determine a SF System Efficiency for a second scenario based on a SF Mining Efficiency and a SF Percent Shift Time Difference.

### TECHNICAL FIELD

The present disclosure generally relates to efficiency measurement systems and, more particularly, for such systems utilized in mining and earth moving applications, and the like.

### BACKGROUND

Productivity at a mine site depends on a variety of factors such as the efficient use of trucks and shovels on the site. Productive work time for such a truck occurs when the truck is backing under a loading unit, being loaded, hauling a load, backing up to a dump point and dumping the load. Time spent traveling back to the loading site and waiting for a shovel or to dump is not productive work time for the truck. Productive work time for a shovel occurs when the shovel is performing the loading process for a truck. Time spent waiting for a truck to start the loading process is not productive time for a shovel.

In the past productivity measurements have focused on the tons per shift, the tons per truck per shift, the ton-miles per truck shift, the loads per equipment-shift, and the like. However, comparisons may be difficult because these type of measurements are influenced by the type and size of the equipment used, the haul distances, the haul gradients, the material type as well as whether the mine is under-trucked or over-trucked. A better type of productivity measurement is one that compares the useful work time of a haul truck to the time the equipment is ready to perform useful work.

U.S. Pat. No. 5,528,499 issued Jun. 18, 1996 (the '499 Patent) discloses an apparatus for processing data derived from the weight of a load carried by a haulage vehicle. Pressure data and indications of changes in the data are used to establish a historical data base from which various hauling parameters may be monitored. The accumulated data of the historical data base are used to formulate management decisions directed to the future operation of a vehicle. This type of system has drawbacks in that such data is subject to a multitude of day-to-day performance and work site variables which may unduly skew the results. A better system is needed.

### SUMMARY OF THE DISCLOSURE

In accordance with one aspect of the disclosure, a system is disclosed. The system may comprise a loading machine, a first fleet (FF), a second fleet (SF), and a controller connected to the loading machine and the first vehicle fleet and the second vehicle fleet. The controller may be configured to determine a FF System Efficiency for the first fleet by multiplying a FF Mining Efficiency by a FF Percent Shift Time Difference. The controller may be further configured to determine a SF System Efficiency for the second fleet by multiplying a SF Mining Efficiency by a SF Percent Shift Time Difference.

In accordance with another aspect of the disclosure, a method of determining and comparing System Efficiencies is disclosed. The method may comprise calculating, by a controller, a FF Mining Efficiency and a FF Percent Shift Time Difference for a first scenario, and determining, by the controller, a FF System Efficiency from the FF Mining Efficiency and the FF Percent Shift Time Difference. The method may further comprise calculating, by the controller, a SF Mining Efficiency and a SF Percent Shift Time Difference for a second scenario, and determining, by the controller, a SF System Efficiency from the SF Mining Efficiency and the SF Percent Shift Time Difference.

In accordance with a further aspect of the disclosure, a computer program product is disclosed. The computer program product may comprise a non-transitory computer usable medium having a computer readable program code embodied therein. The computer readable program code may be adapted to be executed to implement a method for determining and comparing System Efficiencies, the method comprising calculating a FF Mining Efficiency and a FF Percent Shift Time Difference for a first scenario, determining a FF System Efficiency based on the FF Mining Efficiency and the FF Percent Shift Time Difference, calculating a SF Mining Efficiency and a SF Percent Shift Time Difference for a second scenario, determining a SF System Efficiency based on the SF Mining Efficiency and the SF Percent Shift Time Difference, and comparing the SF System Efficiency to the FF System Efficiency to determine which is greater.

### BRIEF DESCRIPTION OF THE DRAWINGS

FIG. 1 is a general schematic view of an exemplary embodiment of a system constructed in accordance with the teachings of this disclosure;

FIG. 2 is general schematic of an embodiment of an exemplary haul cycle;

FIG. 3 is flowchart illustrating exemplary steps of a method of determining System Efficiencies in accordance with the teachings of this disclosure; and

FIG. 4 is an exemplary table of scenario values.

### DETAILED DESCRIPTION

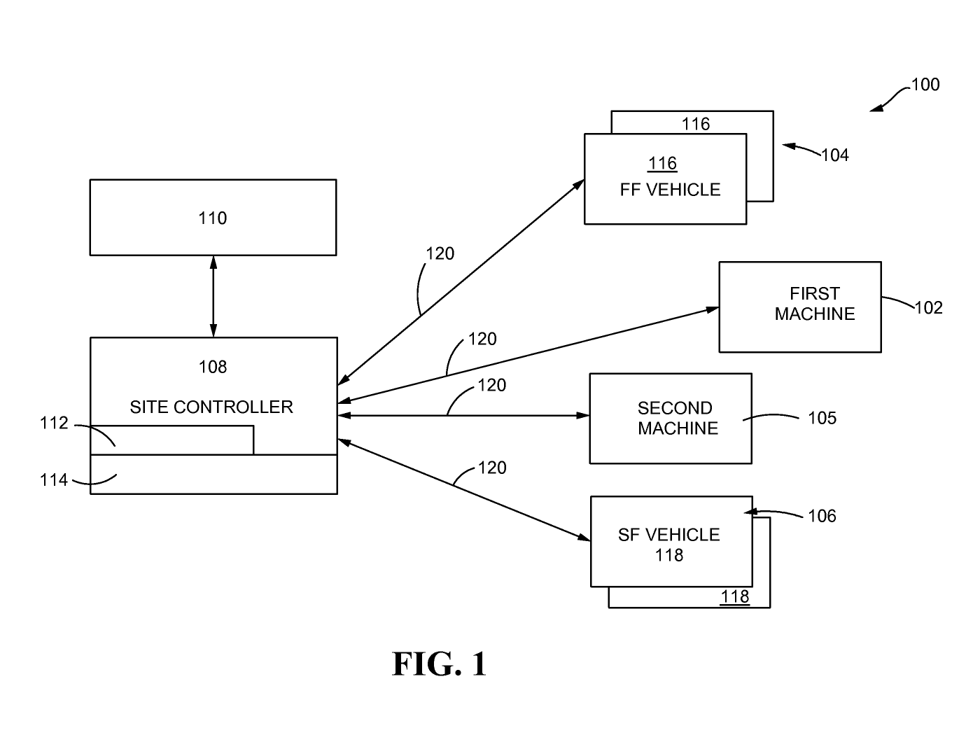

Referring now to the drawings, and with specific reference to FIG. 1, there is shown a schematic diagram of an exemplary embodiment of a system in accordance with the present disclosure and generally referred to by reference numeral 100. While the following detailed description and drawings are made with reference to an exemplary system utilized in a mining application, the teachings of this disclosure may be employed in other applications in which it is desired to comparatively monitor the System Efficiencies of operational scenarios.

The exemplary system 100 may comprise a first machine 102 (or group of machines 102 of the same status), a first fleet 104, a second machine 105 (or group of machines 105 of the same status), a second fleet 106, a site controller 108, and an input/output apparatus 110. The status of the first and second machines may be manned, unmanned or semi-autonomous.

The first fleet 104 may comprise one or more vehicles (or machines) of the same status. The status may be manned, unmanned or semi-autonomous. For the purpose of illustration of the principles described herein, the first fleet 104 in the exemplary embodiment may comprise one or more vehicles (herein referred to as “FF vehicles” 116).

Similarly, the second fleet 106 may comprise one or more vehicles (or machines) of the same status. The status may be manned, unmanned or semi-autonomous. For the purpose of illustration of the principles described herein, the second fleet 106 in the exemplary embodiment may comprise one or more vehicles (herein referred to as “SF vehicles” 118).

As noted above, the status of the FF vehicles 116 and the SF vehicles 118 may be manned, unmanned or semi-autonomous. An unmanned vehicle (or machine) may be controlled by the site controller 108 instead of a human operator. Unmanned vehicles may include an on-board controller (not shown) operatively connected to the site controller 108 via a communication link 120. The on-board controller may operate a vehicle 116, 118 through communication with the steering assembly, power source(s), transmission devices, hydraulic pumps, traction devices, and the like of the vehicle.

Manned vehicles have a human operator controlling the vehicle's 116, 118 actions. In some embodiments, manned vehicles may include an on-board controller (not shown) or sensors (not shown) that provide information about the vehicle's location or functions to the site controller 108 through a communication link 120.

Semi-autonomous vehicles or machines may have a site-controller 108 that controls some, but not all, of the functions/operations of the vehicle or machine 116, 118. A human may control some of the functions. Such control may be from within the cab or may be remote from the vehicle or machine 116, 118.

In some embodiments, location sensors on the work site or a Global Positioning System (GPS) may provide information, such as the location of the machine or vehicle, to the site controller 108 via a communication link 120.

To illustrate the principles of this disclosure, in the exemplary embodiment, the first fleet 104 of FF vehicles 116 may comprise eight manned haul trucks and the second fleet 106 of SF vehicles may comprise ten unmanned haul trucks 118. While the following detailed description and drawings are made with reference to exemplary FF vehicles 116 and SF vehicles 118 that are haul trucks, the teachings of this disclosure may be employed on other mining, earth moving, or the like, machines or vehicles. For example, the teachings of this disclosure may be employed on forklifts, haulers, ships, planes trains, spacecraft, and the like capable of hauling materials and/or freight and/or cargo and the like.

The first machine 102 may comprise one or more machines. In the exemplary embodiment, the first machine 102 may be a mining shovel, as is known in the art for loading. More specifically, the first machine 102 may be configured to load material onto a FF vehicle 116 positioned at a loading point. Similarly, the second machine 105 may comprise one or more machines. In the exemplary embodiment, the second machine 105 may be a mining shovel, as is known in the art for loading. More specifically, the second machine 105 may be configured to load material onto a SF vehicle 118 positioned at a loading point. The teachings of this disclosure may also be utilized with machines other than mining shovels. For example, the teachings of this disclosure may be utilized with one or machines that are loading device(s) such as, but not limited to, cranes, forklifts, front-end loaders, excavators, dozers, draglines, Load-Haul-Dump (LHD) vehicles and the like.

The site controller 108 may include a processor 112 and a memory component 114. The site controller 108 may be operably connected through communication links 120 to each of the FF vehicles 116 of the first fleet 104, each of the SF vehicles 118 of the second fleet 106, the first machine 102 and the second machine 105. The site controller 108 may also be operably connected through a communication link 120 to an input/output apparatus 110.

The communication link 120 may be hardware and/or software that enables the transmission and receipt of data messages through a direct data link or a wireless communication link. The wireless communicated may include, for example, satellite, radio (voice and/or data), cellular, infrared, Ethernet, and the like.

The processor 112 may be a microprocessor or other processor as known in the art. The processor 112 may execute instructions and generate control signals for FF vehicle 116 and/or SF vehicle 118 and/or first machine 102 and/or second machine 105 control, and for calculation of a Mining Efficiency, a Percent Shift Time Difference, and a System Efficiency. Such instructions may be read into or incorporated into a computer readable medium, such as the memory component 114 or provided external to the processor 112. In alternative embodiments, hard wired circuitry may be used in place of, or in combination with, software instructions to implement a control method.

The term “computer readable medium” as used herein refers to any non-transitory medium or combination of media that participates in providing instructions to the processor 112 for execution. Such a medium may comprise all computer readable media except for a transitory, propagating signal. Common forms of computer-readable media include, for example, a floppy disk, a flexible disk, hard disk, magnetic tape, or any other magnetic medium, a CD-ROM, DVD, any other optical medium, or any other medium from which a computer processor 112 can read.

The site controller 108 is not limited to one processor 112 and memory component 114. The controller 108 may be several processors 112 and memory components 114.

The site controller 108 may be configured to receive, collect or calculate information related to the work site, the machines 102, 105 the fleets 104, 106, and the like. Information may be calculated, input, or may be received from on-board controllers on a machine 102, 105, or vehicle 116, 118, positioning sensors disposed on the work site, a satellite, or elsewhere. Such information may be stored in the memory component 114 and/or onboard a machine 102, 105, or vehicle 116, 118.

Consistent with one embodiment, such information may include the location, capacity, type and amount of material (either specific or generalized) moved (for example, per load, cumulative and the like), amount of material moved per hour (for example, tons per hour), type and quantity of the machines 102, 105 and fleet vehicles/machines 116, 118. The information may also include the distance traveled by the vehicles/machines 116, 118 of each fleet 104, 106. For example, the haul distance when loaded and the haul distance when empty. The speed of such vehicles/machines 116, 118 may also be included in the information. The information may also include the time duration for various functions of the machine(s) 102, 105 and the fleet vehicle(s)/machine(s) 116, 118. For example, the information may include the loading time, swing time, hang time, wait time, cleanup, moving, etc. of the shovel(s)) 102, 105, the travel time for fleet vehicles/machines 116, 118 when loaded, the time for fleet vehicles/machines 116, 118 to backup, the time for fleet vehicles/machines 116, 118 to dump a load, the travel time for fleet vehicles/machines 116, 118 when empty, the wait time for the machine(s) 102, 105 and the queue time for the fleet vehicles/machines 116, 118. In addition, the information may include the number of hours working, the number of shifts, the availability of each fleet 104, 106, the utilization of each fleet 104, 106, the number of equivalent vehicles/machines 116, 118 in each fleet 104, 106, the number of available vehicles/machines 116, 118 in each fleet 104, 106, and the number of machines 102, 105 and fleet vehicles/machines 116, 118 required. The information may further include the Machine Efficiency (for example, in the illustrative embodiment, the shovel efficiency), the fleet vehicle efficiency (for example, in the illustrative embodiment, the trucking efficiency), and the Mining Efficiency. The controller may be configured to retrieve from the memory 114 some or all of the information discussed above.

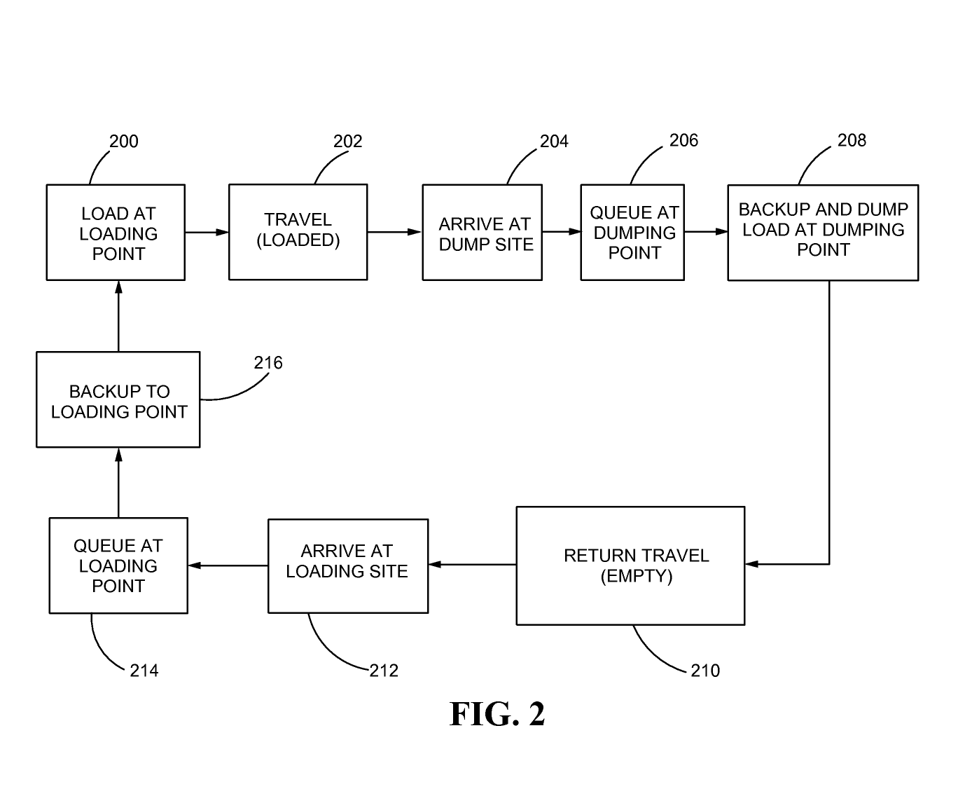

In the exemplary embodiment of FIG. 1, the work cycle sequence of actions for each of the haul trucks 116, 118 is illustrated in general terms in FIG. 2. In the first step 200 of the cycle, a haul truck 116,118 may be loaded by a shovel 102,105 at the loading point. In the second step 202, the haul truck 116,118 may travel in a loaded condition to a dump site. After arriving at the dump site (step 204), the next step (206) may be to queue at the dumping point. Step 206 may be eliminated if there is no queue at the dumping point. In step 208, the haul trucks 116, 118 may backup/position the truck and dump (collectively, “dump”) the load at the dumping point. The next step 210 may be for the haul truck 116, 118 to travel back, in an empty condition, to the loading site. After arriving at the loading site (step 212), the next step 214 may be for the haul truck 116, 118 to wait in a queue for the shovel 102, 105. Step 214 may be eliminated if, for the fleet vehicles 116, 118 (haul trucks), there is no wait time for the shovel 102, 105. In step 216, the haul trucks 116, 118 may backup or position under the loading point to receive the next load. In some embodiments, dispatching algorithms, known in the art, exist that compute the time expected (i.e. the “optimal time”) for trucks to travel to assigned dumps full or partially loaded, and the time expected (i.e. the optimal time) for trucks to travel to assigned loading units empty. These times may be used for certain computations in determining the trucking efficiency as is known in the art.

### INDUSTRIAL APPLICABILITY

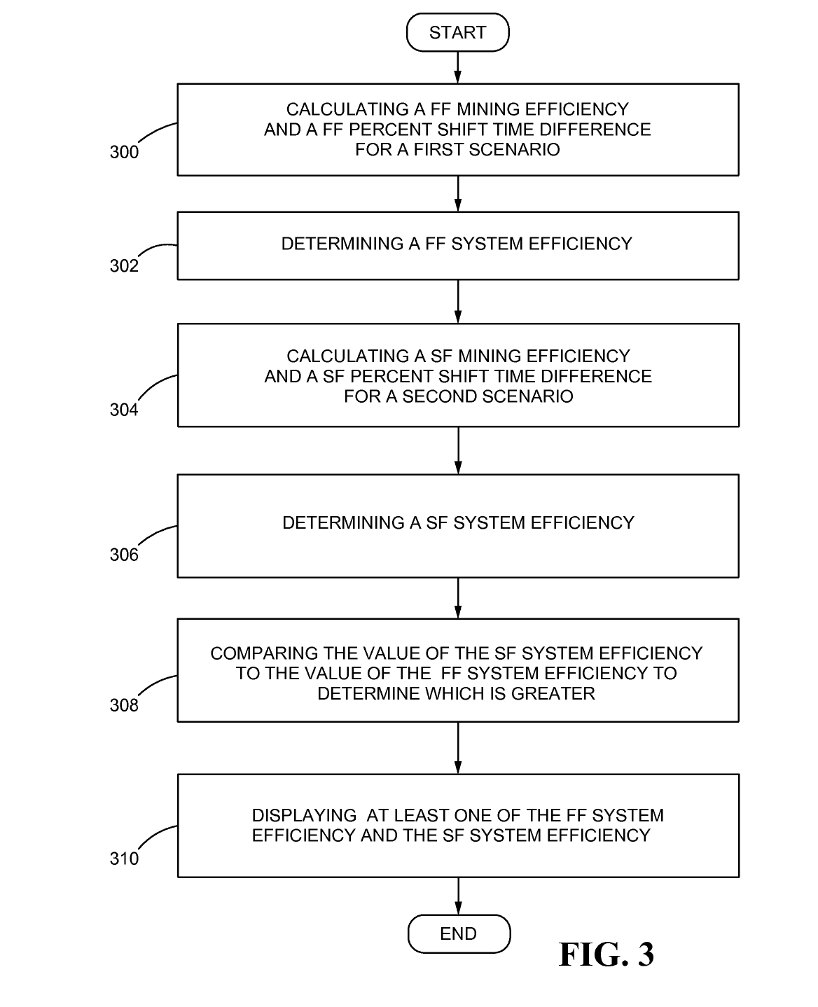

Referring now to FIG. 3, an exemplary flowchart is illustrated showing sample steps which may be followed to determine the System Efficiency for a scenario. The method may be practiced with more or less than the number of steps shown and is not limited to the order shown.

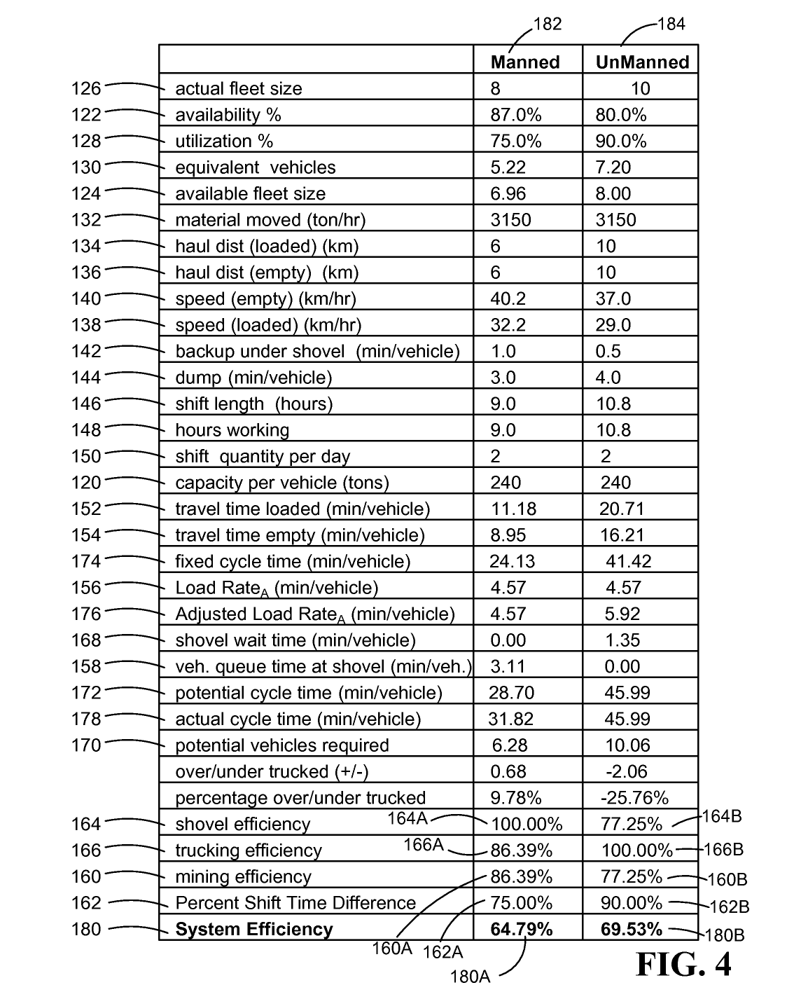

The table illustrated in FIG. 4, provides information for two exemplary scenarios for the system illustrated in FIG. 1. In each, the haul cycle is generally like that depicted in FIG. 2. The first scenario 182 is for an exemplary embodiment in which the first fleet 104 includes eight manned FF vehicles 116. The second scenario 184 is for an exemplary embodiment in which the second fleet 106 includes ten unmanned SF vehicles 118.

In the first scenario 182, the FF vehicles 116 may be haul trucks. In other embodiments, the first fleet 104 could include just one manned vehicle, or, alternatively, one or more manned, unmanned vehicles or semi-autonomous vehicles. In scenarios where a fleet includes a plurality of vehicles, the scenario information may represent averages and/or discrete components, where appropriate.

As can be seen in the table of FIG. 4, each FF vehicle 116 has a load capacity 120 of about 240 tons. In the exemplary scenario, the availability percentage 122 for the first fleet 104 is about eighty-seven percent. Meaning, at any given time, about eighty-seven percent of the FF vehicles 116 are generally available. Thus, the available fleet size 124 of the first fleet 104 is about 6.96 haul trucks. In an embodiment, the available fleet size 124 may be calculated as the product of the actual fleet size 126 and the availability percentage 122.

In the exemplary scenario, the first fleet 104 has a utilization percentage 128 of about seventy-five percent. Meaning that the FF vehicles 116 are utilized about seventy-five percent of the time that they are available. This is roughly about the equivalent of 5.22 FF vehicles 116 (haul trucks). The equivalent vehicles 130 may be calculated, as is known in the art, as the product of the actual fleet size 126 and the availability percentage 122 and the utilization percentage 128.

In the exemplary first scenario 182, each FF vehicle 116 in the first fleet 104 hauls about 3,150 tons per hour (material moved 132). The loaded haul distance 134, the distance between the loading point and the dumping point, is about six kilometers. The empty haul distance 136, the distance between the dumping point and the loading point, is about six kilometers.

In the exemplary embodiment, the example used for the speed of the FF vehicle 116 when loaded (the loaded speed 138) is about 32.2 kilometers per hour and, when empty (the empty speed 140), is about 40.2 kilometers per hour. On average for this example, each FF vehicle 116 takes about one minute to backup 142 to the loading point under the shovel and about three minutes to dump 144 the load (in this example, the time to dump the load includes the time to backup to/position the haul truck at the dumping point and the time to actually dump the load). The effective shift length (i.e. the time the equipment is made available to work during a normal shift period) 146 per FF vehicle 116 is about nine hours and the hours working (i.e. the effective shift length minus any planned and/or unplanned delays not included in the computation(s) for the effective shift length) 148 the shift is about nine hours. In the exemplary first scenario 182, each working FF vehicle 116 in the first fleet 104 works a shift quantity 150 of two shifts per day. In the exemplary embodiment, the example used for travel time when loaded 152 for each of the FF vehicles 116 is about 11.18 minutes and when empty 154 is about 8.95 minutes. The first machine 102 (shovel) takes about 4.57 minutes to load (Load Rate_{A} 156) each FF vehicle 116. The vehicle queue time 158 at the loading point is about 3.11 for each of the FF vehicles 116. The numbers referenced herein are meant to illustrate the computations. Such numbers may be typically measured values in an actual operation although one or more may be manually entered.

Step 300 of the method disclosed herein includes calculating, by a controller 108, a Mining Efficiency 160 for a first scenario 182 (“FF Mining Efficiency” 160a) and a Percent Shift Time Difference 162 for the first scenario 182 (“FF Percent Shift Time Difference” 162A). The FF Mining Efficiency 160A may be calculated as is known in the art. In the exemplary embodiment, the example FF Mining Efficiency 160A was calculated to be about 86.39 percent for the exemplary first scenario 182 having a first machine 102 that is a shovel and a first fleet 104 of FF vehicles 116 that are haul trucks. The Mining Efficiency 160 may be calculated as the product of the shovel efficiency (S_{E}) 164 and the trucking efficiency (T_{E}) 166.

The shovel efficiency S_{E} 164 may be calculated according to calculations known in the art. One such calculation for S_{E} 164 that may be used is S_{E}=(Load Rate_{A})/(Adjusted Load Rate_{A}+shovel wait time). Where the Load Rate_{A} 156 is the number of minutes it takes to load a fleet vehicle. In this example, the machine (shovel) wait time 168 is the amount of time, per fleet vehicle (truck), that the first machine 102 (shovel) must wait for a FF vehicle 116 (haul truck) to be available for loading. In the exemplary scenario with the manned FF vehicles 116, the first machine 102 (shovel) does not have to wait for the FF vehicles 116 (haul trucks).

The value of the Adjusted Load Rate_{A} 176 depends on whether the scenario is over-trucked or evenly trucked, or whether the scenario is under-trucked. The scenario is under-trucked if the number of potential vehicles (trucks) required 170 is greater than the available fleet size 124. The scenario is over-trucked if the potential trucks required 170 is less than the available fleet size 124. The scenario is evenly trucked if the potential trucks required 170 is equal to the available fleet size 124.

The exemplary first scenario 182 is over-trucked because the value for the potential FF vehicles 116 (manned haul trucks) required 170 is about 6.28 trucks and the value for the available fleet size 124 is about 6.96 trucks. The value for the potential vehicles required 170 may be obtained by dividing the potential cycle time 172 per truck by the Load Rate_{A} 156. The potential cycle time 172 per truck is the minimum cycle time per truck with no delay. It may be calculated as the fixed cycle time 174 per truck plus the Load Rate_{A} 156 plus the backup time under the shovel. The fixed cycle time 174 may include the time per truck to travel when loaded 152, to backup under the shovel 142, to dump 144 the load (including time to backup/position the truck to dump), and to travel when empty 154. Other appropriate algorithms may also be used.

If overtrucked or evenly trucked, the Adjusted Load Rate_{A} 176 may be calculated, as is known is the art, as Adjusted Load Rate_{A}=((1/X_{R}) * capacity)*(60 minutes), where X_{R} 132 is the average instantaneous loading rate (i.e. how fast a loading unit can load an individual truck from the start of the loading sequence to the end of the loading sequence represented as a tons/hour rate).

If scenario is under-trucked and the value for the available fleet size 124 is greater than one, the Adjusted Load Rate_{A} 176 may be calculated, as is known in the art, as Adjusted Load Rate_{A}=fixed cycle time/(available fleet size−1). If the value for the available fleet size 124 is less than or equal to one, the Adjusted Load Rate_{A} 176 may be calculated as Adjusted Load Rate_{A}=fixed cycle time/(available fleet size), i.e. the Adjusted Load Rate is the Actual Load Rate.

Since the first scenario 182 is over-trucked, the shovel efficiency S_{E} 164A is about 100 percent as there should always be a truck at the shovel ready to load.

The trucking efficiency T_{E} 166 may be calculated according to calculations known in the art. One such calculation for T_{E} 166 that may be used is T_{E}=(Load Rate_{A}+backup time at the shovel+travel time when loaded per truck+backup time at dumping point per truck+dumping time per truck)/(actual cycle time per truck−travel time per truck when empty). (In the exemplary scenario, the backup time per truck at the dumping point and the dumping time have been combined to simplify the exemplary calculations.) Where actual cycle time 178 includes the potential cycle time 172 plus the vehicle queue time 158 per truck. In some embodiments, the travel time per truck when empty may be the optimal travel time (typically using the shortest route) back to a shovel location and may be typically a computed value based on measurements taken by and/or other data that might be entered automatically and/or manually into the site controller 108 and which can be used by the controller 108 for optimizing the traffic flow in the mine using traditional algorithms as is known is the art. This subtraction from the cycle time in the denominator normalizes the effect empty travel time will have on the computation to 100% in the ideal case. In the exemplary scenario discussed above, using the exemplary values listed in FIG. 4, the T_{E} 166A is about 86.39 percent. Other appropriate algorithms may also be used. Given the above calculations, the FF Mining Efficiency 160 in the exemplary first scenario 184 is about 86.39 percent.

The Percent Shift Time Difference 162 accounts for the percentage of time actually used compared with the available time in the shift and may be calculated using the following equation: Percent Shift Time Difference=working hours/(24 hours/number of shifts). The FF Percent Shift Time Difference is about seventy-five percent in the first scenario.

Step 302 of the method is determining, by the controller, a FF System Efficiency 180A for the first scenario 182 from the FF Mining Efficiency 160A and the FF Percent Shift Time Difference 162A. The System Efficiency 180 is the product of the Mining Efficiency 160 and the Percent Shift Time Difference 162. In the exemplary embodiment, the FF System Efficiency 180A is about 64.79 percent.

Step 304 of the method includes calculating, by a controller 108, a Mining Efficiency 160 for a second scenario 184 (“SF Mining Efficiency” 160B) and a Percent Shift Time Difference 162 for a second fleet 106 (“SF Percent Shift Time Difference” 162B) in exemplary second scenario 184.

In the exemplary second scenario 184 (see FIG. 4), the second fleet 106 has a fleet size 126 of ten unmanned SF Vehicles 118. The SF vehicles 118 may be haul trucks. In other embodiments, the second fleet 106 may include just one unmanned vehicle, or alternatively, one or more manned, unmanned or semi-autonomous vehicles.

As can be seen in the examplary table of FIG. 4, each SF vehicle 118 has a load capacity 120 of about 240 tons. The availability percentage 122 of the second fleet 106 is about eighty percent. Meaning, at any given time, about eighty percent of the SF vehicles 118 are generally available. Thus, the available fleet size 124 of the second fleet 106 is about eight unmanned haul trucks.

In the exemplary embodiment, the SF vehicles 116 are utilized about ninety percent of the time that they are available. Thus, in the second scenario 184, the utilization percentage 128 for the second fleet 106 is about ninety percent. This results in an equivalent vehicle 130 amount of about 7.2 SF vehicles 118.

In the exemplary scenario, the material moved 132 by each SF vehicle 118 in the second fleet 106 is about 3150 tons per hour. The loaded haul distance 134, the distance between the loading point and the dumping point, is about ten kilometers. The empty haul distance 136, the distance between the dumping point and the loading point, is about ten kilometers.

In the exemplary embodiment, the loaded speed 138 of the SF vehicle 118 is about twenty-nine kilometers per hour and, the empty speed 140 is about thirty-seven kilometers per hour. On average, each SF vehicle 118 takes about half a minute to backup 142 to the loading point and about four minutes to backup to the dumping point and dump 144 the load. The shift length 146 and hours working 148 per SF vehicle 118 is about 10.8 hours. In the exemplary second scenario 184, each working SF vehicle 116 in the second fleet 106 works a shift quantity 150 of two shifts per day. In the exemplary embodiment, the travel time when loaded 152 for each of the SF vehicles 118 is about 20.71 minutes and when empty 154 is about 16.21 minutes. The second machine (shovel) 105 takes about 4.57 minutes (Load Rate_{A} 156) to load each SF vehicle 118. In the exemplary second scenario 184, there is no queue time 158 for each of the SF vehicles 118. However, for the second machine 105 (shovel) there is a wait time 168 of about 1.35 minutes for each SF vehicle 118 to be available for loading.

The calculations utilized are the same as those discussed previously. Since the potential trucks required 170 for the second scenario 184 is greater than the available (second) fleet size 124, the second scenario 184 is under trucked. The S_{E} 164B for the second shovel 105 was calculated to be about 77.25 percent. The T_{E} 166B for the second fleet 106 was calculated to be 100 percent, and the Mining Efficiency 160B for the second scenario 184 utilizing unmanned vehicles was calculated to be about 77.25 percent. The SF Percent Shift Time Difference 162B was calculated to be about 90 percent.

Step 306 of the method is determining, by the controller 108, a SF System Efficiency 180B for the second scenario 184 from the SF Mining Efficiency 160B and the SF Percent Shift Time Difference 162B. As discussed earlier, System Efficiency 180 is the product of the Mining Efficiency 160 and the Percent Shift Time Difference 162. In the exemplary embodiment, the SF System Efficiency 180B is about 69.53 percent.

Step 308 includes comparing the SF System Efficiency 180B to the FF System Efficiency 180A to determine which value is greater. Step 310 includes displaying the FF System Efficiency 180A and the SF System Efficiency 180B on an input/output apparatus 110. Such apparatus 110 may be a display screen, a printer, and the like.

As can be seen, the above novel approach illustrates that the second scenario 184, utilizing SF vehicles 118 of the second fleet 106, which in this case are unmanned, is more efficient than the first scenario 182 that utilizes the manned FF vehicles 116 of the first fleet 104.

Also disclosed is a computer program product, comprising a non-transitory computer usable medium having a computer readable program code embodied therein, the computer readable program code adapted to be executed to implement a method for determining and comparing System Efficiencies 180 in a mining operation, the method comprising calculating a FF Mining Efficiency 160A and a FF Percent Shift Time Difference 162A for a first scenario 182, determining a FF System Efficiency 180A based on the FF Mining Efficiency 160A and the FF Percent Shift Time Difference 162A, calculating a SF Mining Efficiency 160B and a SF Percent Shift Time Difference 162B for a second scenario 184, determining a SF System Efficiency 180B based on the SF Mining Efficiency 160B and the SF Percent Shift Time Difference 162B, and comparing the SF System Efficiency 180B to the FF System Efficiency 180A to determine which is greater.

The features disclosed herein may be particularly beneficial for use with autonomous, semi-autonomous and manned mining, earth moving, construction or material handling vehicles. In addition, the features disclosed herein may be particularly beneficial when attempting to compare a manned operation with an unmanned operation operating in a similar operating environment.

What is claimed is:

1. A system comprising:
a loading machine;
a first fleet;
a second fleet; and
a controller connected to the loading machine and the first fleet and the second fleet, the controller configured to determine a FF System Efficiency for a first scenario by multiplying a FF Mining Efficiency by a FF Percent Shift Time Difference, the controller configured to determine a SF System Efficiency for a second scenario by multiplying a SF Mining Efficiency by a SF Percent Shift Time Difference.

2. The system of claim 1, wherein the first fleet is a plurality of manned vehicles.

3. The system of claim 2, wherein the manned vehicles are haul trucks.

4. The system of claim 2, wherein the second fleet is a plurality of unmanned vehicles.

5. The system of claim 4, wherein the unmanned vehicles are haul trucks.

6. The system of claim 1, wherein the second fleet consists of one unmanned vehicle.

7. The system of claim 1, wherein the first fleet consists of one manned vehicle.

8. The system of claim 1, wherein the loading machine is a shovel.

9. The system of claim 1, wherein the first fleet is a plurality of manned vehicles configured to receive and carry a load and the second fleet is a plurality of manned vehicles configured to receive and carry a load.

10. A method of determining and comparing System Efficiencies, the method comprising:
calculating, by a controller, a FF Mining Efficiency and a FF Percent Shift Time Difference for a first scenario;
determining, by the controller, a FF System Efficiency from the FF Mining Efficiency and the FF Percent Shift Time Difference;
calculating, by the controller, a SF Mining Efficiency and a SF Percent Shift Time Difference for a second scenario; and
determining, by the controller, a SF System Efficiency from the SF Mining Efficiency and the SF Percent Shift Time Difference.

11. The method of claim 10, further comprising comparing the SF System Efficiency to the FF System Efficiency to determine which is greater.

12. The method of claim 10, further comprising displaying the FF System Efficiency and the SF System Efficiency.

13. The method of claim 10, wherein the first fleet is comprised of manned vehicles.

14. The method of claim 13, wherein the manned vehicles are haul trucks.

15. The method of claim 13, wherein the second fleet is comprised of unmanned vehicles.

16. The method of claim 15, wherein the unmanned vehicles are haul trucks.

17. A computer program product comprising a non-transitory computer usable medium having a computer readable program code embodied therein, the computer readable program code adapted to be executed to implement a method for determining and comparing System Efficiencies, the method comprising:
calculating a FF Mining Efficiency and a FF Percent Shift Time Difference for a first scenario;
determining a FF System Efficiency based on the FF Mining Efficiency and the FF Percent Shift Time Difference;
calculating a SF Mining Efficiency and a SF percent shift time difference for a second scenario;
determining a SF System Efficiency based on the SF Mining Efficiency and the SF Percent Shift Time Difference; and
comparing the SF System Efficiency to the FF System Efficiency to determine which is greater.

18. The method of claim 17, wherein the first fleet is comprised of manned haul trucks.

19. The method of claim 17, wherein the second fleet is comprised of unmanned haul trucks.

20. The method of claim 17, wherein the first fleet is comprised of manned haul trucks, the second fleet is comprised of unmanned haul trucks, and the first scenario includes includes a first shovel configured to load the manned haul trucks and the second scenario includes a second shovel configured to load the unmanned haul trucks.
